(19) United States
(12) Patent Application Publication
(10) Pub. No.: US 2018/0365218 A1
(43) Pub. Date: Dec. 20, 2018

(54) TEXT INFORMATION CLUSTERING METHOD AND TEXT INFORMATION CLUSTERING SYSTEM

(71) Applicant: ALIBABA GROUP HOLDING LIMITED, George Town (KY)

(72) Inventors: Zihao FU, Hangzhou (CN); Kai ZHANG, Hangzhou (CN); Ning CAI, Hangzhou (CN); Xu YANG, Hangzhou (CN); Wei CHU, Hangzhou (CN)

(21) Appl. No.: 16/116,851

(22) Filed: Aug. 29, 2018

Related U.S. Application Data
(63) Continuation of application No. PCT/CN2017/073720, filed on Feb. 16, 2017.

(30) Foreign Application Priority Data
Feb. 29, 2016 (CN) 201610112522.X

(51) Int. Cl. G06F 17/27; G06K 9/00; G06F 17/28; G06K 9/62

(52) U.S. Cl. CPC G06F 17/2775; G06K 9/6218; G06F 17/2863; G06K 9/00463

(57) ABSTRACT

Embodiments of the disclosure provide a text information clustering method and a text information clustering system. The method can include performing word segmentation on multiple pieces of text information to generate multiple words; performing an initial clustering on the multiple words to generate multiple first-level topics, each of the first-level topics comprising at least two pieces of text information; determining, for each of the first-level topics, a number of second-level topics based on a number of pieces of text information under the first-level topic; and performing, according to the number of second-level topics of each of the first-level topics, a secondary clustering on the multiple words of at least two pieces of text information comprised in the first-level topic to generate multiple second-level topics.

### CROSS REFERENCE TO RELATED APPLICATION

The disclosure claims the benefits of priority to International application number PCT/CN2017/073720, filed Feb. 16, 2017, and Chinese application number 201610112522.X, filed Feb. 29, 2016, both of which are incorporated herein by reference in their entireties.

### BACKGROUND

Performing text clustering on text information according to topics is very important in the field of text processing. The text information has extremely wide coverage, and a huge amount of text information is being generated every day. Therefore, it is of great significance to carry out large-scale text clustering analysis.

The conventional text information clustering analysis can become slow in computing and occupy too many computing resources when the number of topics increases. However, if the number of topics is limited, articles under different topics can be mixed together, which affects the final result.

Therefore, it is necessary to propose a new text information clustering technology to solve the above problems of the computing being slow and occupying too many computing resources.

### SUMMARY OF THE DISCLOSURE

In view of the foregoing problems, embodiments of the present application are proposed to provide a text information clustering method and a text information clustering system that can address the foregoing problems or at least partially solve the foregoing problems.

Embodiments of the present application disclose a text information clustering method. The method can include performing word segmentation on multiple pieces of text information to generate multiple words; performing an initial clustering on the multiple words to generate multiple first-level topics, each of the first-level topics comprising at least two pieces of text information; determining, for each of the first-level topics, a number of second-level topics based on a number of pieces of text information under the first-level topic; and performing, according to the number of second-level topics of each of the first-level topics, a secondary clustering on the multiple words of at least two pieces of text information comprised in the first-level topic to generate multiple second-level topics.

Embodiments of the present disclosure disclose a text information clustering system. The system can include: a memory storing a set of instructions; and a processor configured to execute the set of instructions to cause the system to: perform word segmentation on multiple pieces of text information to generate multiple words; perform an initial clustering on the multiple words to generate multiple first-level topics, each of the first-level topics comprising at least two pieces of text information; determine, for each of the first-level topics, a number of second-level topics based on a number of pieces of text information under the first-level topic; and perform, according to the number of second-level topics of each of the first-level topics, a secondary clustering on the multiple words of at least two pieces of text information comprised in the first-level topic to generate multiple second-level topics.

### BRIEF DESCRIPTION OF THE DRAWINGS

FIG. 1 is a schematic diagram of a Latent Dirichlet Allocation (LDA) algorithm.

FIG. 2 is a flowchart of a text information clustering method, according to embodiments of the present disclosure.

FIG. 3 is a flowchart of a text information clustering method, according to embodiments of the present disclosure.

FIG. 4 is a flowchart of a text information clustering method, according to embodiments of the present disclosure.

FIG. 5 is a block diagram of a text information clustering system, according to a fourth embodiment of the present disclosure; and

FIG. 6 is a block diagram of a text information clustering system according to embodiments of the present disclosure.

### DETAILED DESCRIPTION

The technical solution in the embodiments of the present application will be clearly and fully described below with reference to the accompanying drawings in the embodiments of the present application. It is obvious that the embodiments to be described are only some, rather than all, of the embodiments of the present application. All other embodiments derived by those of ordinary skill in the art based on the embodiments of the present application without making creative efforts should fall within the protection scope of the present application.

Embodiments of the present application can perform clustering twice or more times on multiple pieces of text information by using an algorithm, generate multiple first-level topics after a first clustering; then determine a number of second-level topics under each first-level topic according to a number of pieces of text information under each first-level topic; and further perform secondary clustering on at least two pieces of text information under each first-level topic according to the number of second-level topics under each first-level topic, to generate multiple second-level topics.

For example, a system can perform clustering on 5,000 pieces of text information. According to the text information clustering method provided in the present disclosure, the 5,000 pieces of text information can be clustered into 5 first-level topics in a first clustering by using an algorithm. After the first clustering, the numbers of pieces of text information under the first-level topics can be 1,000, 1,500, 500, 1,800, and 200, respectively. Then, a number of second-level topics that each first-level topic may be divided into can be determined according to the number of pieces of text information included under each first-level topic. For example, it can be determined through manual analysis or algorithmic parameter setting that the 5 first-level topics should be divided into 10, 15, 5, 18, and 2 second-level topics, respectively. Next, secondary clustering can be performed on each first-level topic according to the number of the second-level topics, to generate 10, 15, 5, 18, and 2 second-level topics, and each second-level topic includes a number of pieces of text information.

It is appreciated that, the number of pieces of text information to be processed can be far more than 5,000, and may be at a higher order of magnitude. The foregoing example of the present disclosure is only intended to facilitate the understanding instead of making special limitations.

In embodiments of the present disclosure, multiple pieces of text information can be clustered by using a Latent Dirichlet Allocation (LDA) algorithm. The LDA algorithm is a second-level document topic algorithm. The algorithm introduces a Bayesian framework into a conventional Probabilistic Latent Semantic Analysis (pLSA) algorithm, and can better describe a document generation model. pLSA will be briefly described as follows:

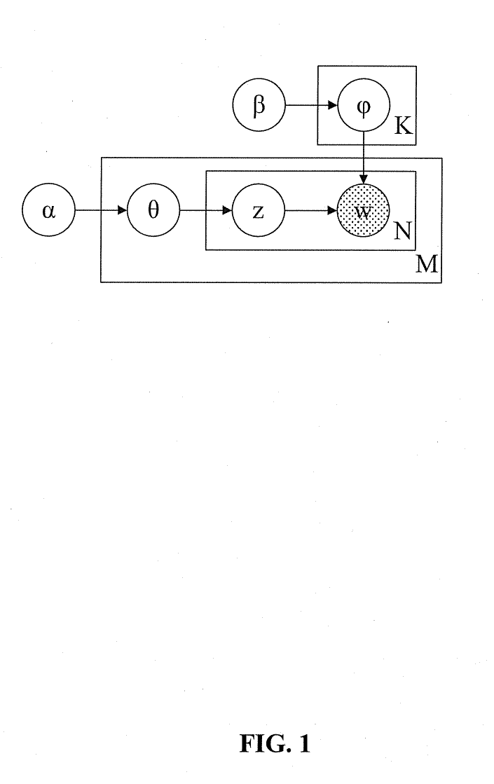

First of all, it is assumed that each word in all documents is selected from a topic of a certain piece of text information, and the topic also satisfies a certain probability distribution. FIG. 1 shows a schematic diagram of an LDA algorithm. As shown in FIG. 1, it is assumed that topics of text information follow a multinomial distribution with a parameter of θ, a prior distribution is a Dirichlet distribution with a parameter of α, and z indicates a topic obtained from the topic distribution. For each topic, it is assumed that words under the topic also follow a multinomial distribution with a parameter of Φ, and a prior distribution of this part is a Dirichlet distribution with a parameter of β. It is assumed that there are a total of K topics, and corresponding words are acquired from the corresponding distribution of each randomly selected topic. In FIG. 1, M indicates the number of articles, N indicates the number of words, K indicates the number of topics, w indicates words, the deepened color indicates content that can be observed, the block indicates repetition, and the number of repetitions is represented by the letter in the lower right corner. Upon completion of modeling, final parameter estimation is completed by Gibbs sampling. After the clustering is completed by using an LDA algorithm, multiple pieces of text information are clustered into specific topics according to the algorithm, and each first-level topic includes multiple pieces of related text information.

When the number of topics is more than 300, the LDA clustering algorithm runs very slowly and occupies a large number of resources. Meanwhile, due to the limitation of the number of topics, an expected number of topics cannot be achieved. Therefore, in a final result, a number of unrelated topics can be mixed together and grouped under one topic, creating a lot of difficulties for text information clustering.

A text information clustering method according to embodiments of the disclosure uses a hierarchical clustering method to construct a hierarchical LDA clustering framework. In an initial clustering, a total number of first-level topics can be decreased, thus improving the computing efficiency and reducing the consumption of system resources. In a secondary clustering, a number of second-level topics can be dynamically determined according to the number of pieces of text information. Thus, the average number of pieces of text information under each second-level topic can be decreased, achieving decoupling between first-level topics and accelerating, in a parallel manner, the computing speed of the second-level topics.

The text information clustering method and the text information clustering system proposed in the present disclosure are specifically described as below.

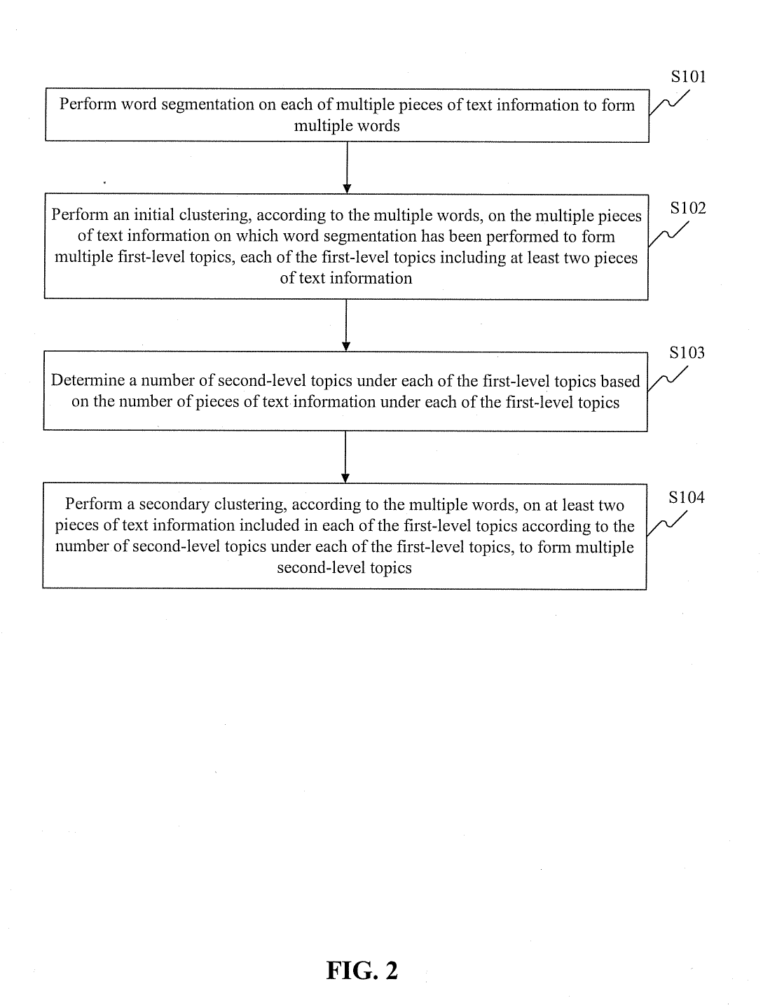

Embodiments of the disclosure provide a text information clustering method. FIG. 2 illustrates a flowchart of a text information clustering method according to embodiments of the present disclosure. The text information clustering method can include steps S101-S104.

In step S101, multiple pieces of text information can be segmented to generate multiple words. For example, word segmentation can be performed on the pieces of text information. The words in this disclosure may also include characters (e.g., Chinese characters, Japanese characters, Korean characters, and the like). For example, a sentence “Python is an object-oriented interpretation-type computer program design language” can be segmented into “Python/is/an/object-/oriented/interpretation-/type/computer/program/design/language”. A sentence can be segmented into several words in step S101 to facilitate the subsequent processing.

In this step, a word included in text information can be compared with a word in a word library. When the word included in text information is the same as the word in the word library, the word can be segmented out of the text information. It should be noted that the word in the disclosure can be a word or a phrase. For example, “oriented” in the text information can be segmented out separately when “oriented” in the text information is the same as “oriented” in the word library. “type” in the text information can be segmented out separately when “type” in the text information is the same as “type” in the word library.

In step S102, an initial clustering can be performed, according to the multiple words, on the segmented pieces of text information, to generate a plurality of first-level topics. Each of the first-level topics can include at least two pieces of text information. The initial clustering can be performed using the above LDA algorithm. In the initial clustering, a number of the first-level topics can be set to a relatively small value as there are a large number of pieces of text information, thus preventing the computing from being slow due to the consumption of too many computing resources. Through the initial clustering, the text information can be classified into several first-level topics. Each first-level topic varies in size and may include a different number of pieces of text information.

For example, according to the foregoing example, when 5,000 pieces of text information are clustered, the 5,000 pieces of text information are clustered into 5 first-level topics by using an LDA algorithm. The numbers of pieces of text information included under the first-level topics are, for example, 1,000, 1,500, 500, 1,800 and 200, respectively.

In step S103, the number of second-level topics under each of the first-level topics can be determined based on the number of pieces of text information under each of the first-level topics according to a preset rule. In this step, the number of second-level topics under each first-level topic can be determined according to the number of pieces of text information under each first-level topic by using a parameter setting of the LDA algorithm or an artificial setting. The number of second-level topics under each first-level topic may be the same or different.

The preset rule is described as below. The preset number of pieces of text information included in each second-level topic is X. The range of X is M≤X≤N, wherein M and N are values designated by a developer or a user. For example, if 90≤X≤110, an average value 100 can be selected for X. Based on this, the number of second-level topics included under each first-level topic in the foregoing example can be determined as: 1,000/100=10, 1,500/100=15, 500/100=5, 1,800/100=18 and 200/100=2.

In step S104, secondary clustering can be performed, according to the multiple words, on multiple pieces of text information included in each of the first-level topics according to the number of second-level topics under each of the first-level topics to form multiple second-level topics. In some embodiments, secondary clustering can be performed on all pieces of text information by using the foregoing LDA algorithm. In the secondary clustering, multiple pieces of text information under each first-level topic can be clustered by using, for example, the LDA algorithm, according to the number of second-level topics into which the first-level topic should be divided to form a designated number of second-level topics.

For example, secondary clustering can be performed for each first-level topic according to the foregoing example to generate 10, 15, 5, 18, and 2 second-level topics respectively. Each second-level topic includes a number of pieces of text information.

As the processes of secondary clustering for the multiple pieces of text information in each first-level topic are independent with each other, the processes of the secondary clustering can be processed at a same time or processed in parallel, thus increasing the computing speed.

In the text information clustering method, a hierarchical clustering method can be used in the text information clustering method according to the above manner. The total number of first-level topics is decreased in initial clustering, thus improving the computing efficiency and reducing the consumption of system resources. In secondary clustering, the number of second-level topics is dynamically determined according to the number of pieces of text information, thus decreasing the average number of pieces of text information under each second-level topic and accelerating the computing speed of the second-level topics.

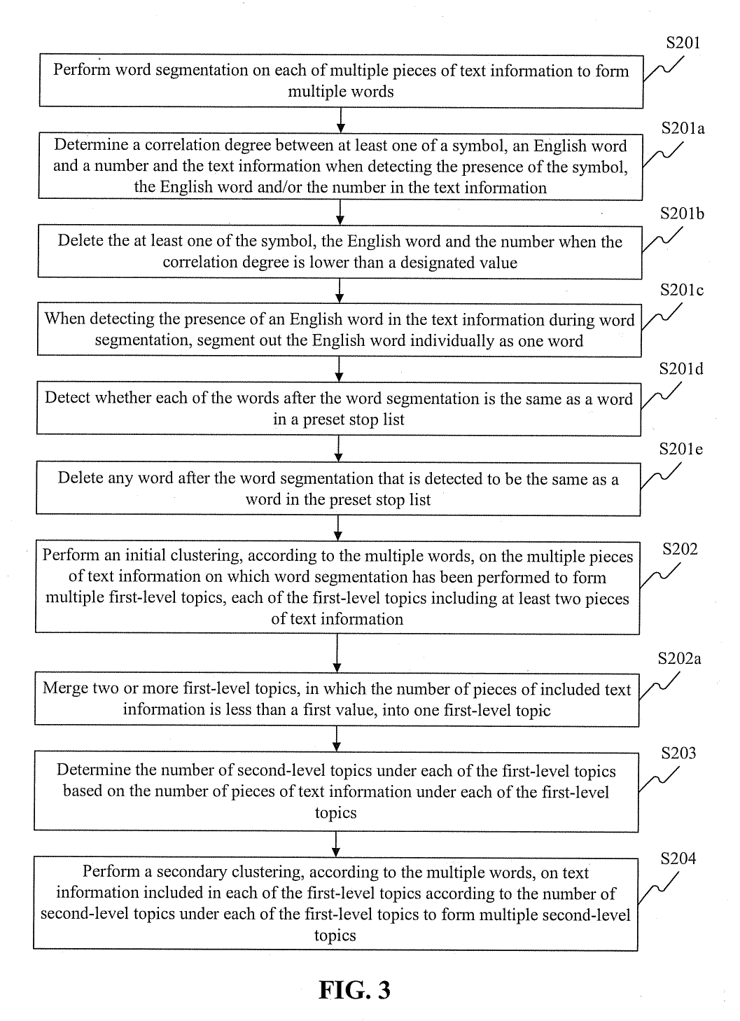

Embodiments of the disclosure also provide a text information clustering method. FIG. 3 illustrates a flowchart of a text information clustering method according to embodiments of the present application. The text information clustering method can includes steps S201-S204.

In step S201, word segmentation can be performed on each of multiple pieces of text information to form multiple words.

In step S202, initial clustering can be performed, by using an LDA algorithm and according to the multiple words, on the multiple pieces of text information on which word segmentation has been performed to form multiple first-level topics, each of the first-level topics including at least two pieces of text information.

In step S203, the number of second-level topics under each of the first-level topics can be determined based on the number of pieces of text information under each of the first-level topics according to a preset rule.

In step S204, secondary clustering can be performed, according to the multiple words (e.g., by using the LDA algorithm) on multiple pieces of text information included in each of the first-level topics according to the number of second-level topics under each of the first-level topics to form multiple second-level topics, each of the second-level topics including multiple pieces of text information.

Steps S201-S204 can be the same as or similar to the above steps S101-S104, and thus are not described in detail here.

In some embodiments, after step S201, the method can further include steps S201a-S201b.

In step S201a, when at least one of a symbol, an English word, or a number can be detected in the text information, a correlation degree of between at least one of a symbol, an English word, or a number or the text information can be determined.

In step S201b, at least one of the symbol, the English word or the number can be deleted in response to the determination that the correlation degree is lower than a designated value.

In the steps above, the symbol may be a separate symbol, such as “&” or “%”, and may also be content consisting of various symbols, numbers and letters, such as a link. A correlation degree can be determined in step S201a by using a particular method.

Similarly, a correlation degree between the English word and content of the text information can be determined. For example, when the text information includes “El Niño phenomenon (El Nino)”, the English word “El Nino” only serves as an annotation. Then, the English word can be deleted as it is only an annotation.

Similarly, a correlation degree between the number and content of the text information can be determined. The number can be deleted when the correlation degree is determined to be low.

In some embodiments, after step S201, the method can further include steps S201c-S201e.

In step S201c, when the presence of an English word is detected in the text information during word segmentation, the English word can be segmented out individually as one word, and the word can be retained. In the above example of “Python is an object-oriented interpretation-type computer program design language”, “Python” is greatly correlated with content of the text information. Therefore, it is impossible to exactly understand the meaning of the text information to obtain accurate classification if “Python” is deleted. Thus, In this example, the word “Python” can be individually segmented out as one word and retained.

In step S201d, it can be detected whether each of the words is included in a preset stop list.

In step S201e, any segmented word that is included in the preset stop list can be deleted.

In the foregoing steps, the result after the word segmentation can includes several meaningless Chinese characters, such as “De ( [symbol] ), Le ( [symbol] ), Guo ( [symbol] )” or English words (e.g., “a,” “an,” “the,” and the like). For example, meaningless words such as “De ( [symbol] ), Le ( [symbol] ), Guo ( [symbol] )” can be gathered in a stop list. These words are not helpful to the result, and still occupy a lot of computational storage resources. Therefore, the words can be filtered out before computing. When such words are present in text information, the words can be deleted from the text information. In addition, some words (e.g., some source marks of text information and the like) may interfere with normal classifications. These words can also be gathered in the stop list. When such words are present in text information, the words can be deleted from the text information.

In addition, it is appreciated that the above steps S201a-S201e may not performed in sequence. For example, step S201a and S201b, S201c and/or S201d and S201e can be performed selectively.

In some embodiments, after step S202, the text information clustering method can further include a step S202a.

In step S202a, two or more first-level topics, in which the number of pieces of included text information is less than a first value, can be merged into one first-level topic. In this step, it can be detected by an algorithm or manually whether the number of pieces of text information under each first-level topic is less than a first threshold. If the number of pieces of text information under each first-level topic is less than a first threshold, the first-level topic can be merged with another first-level topic for subsequent computing. For example, the numbers of pieces of text information included under the first-level topics formed by clustering in step S202 are 1,000, 1,500, 500, 1,800, and 200, respectively. If the first threshold is set to 300, it can be determined that the number of pieces of text information included in the last first-level topic is less than the first threshold. In this case, the last first-level topic can be merged with another topic. For example, the last first-level topic can be merged with the third first-level topic, and then the second-level topics are clustered.

In the text information clustering method, a hierarchical clustering method is used in the text information clustering method. The total number of first-level topics can be decreased in an initial clustering, thus improving the computing efficiency and reducing the consumption of system resources. In a secondary clustering, the number of second-level topics can be dynamically determined according to the number of pieces of text information, thus decreasing the average number of pieces of text information under each second-level topic and accelerating the computing speed of the second-level topics. At the same time, meaningless words and/or symbols are deleted during clustering, first-level topics including a small number of pieces of text information are merged to further optimize the computing method, and the computing load can be reduced.

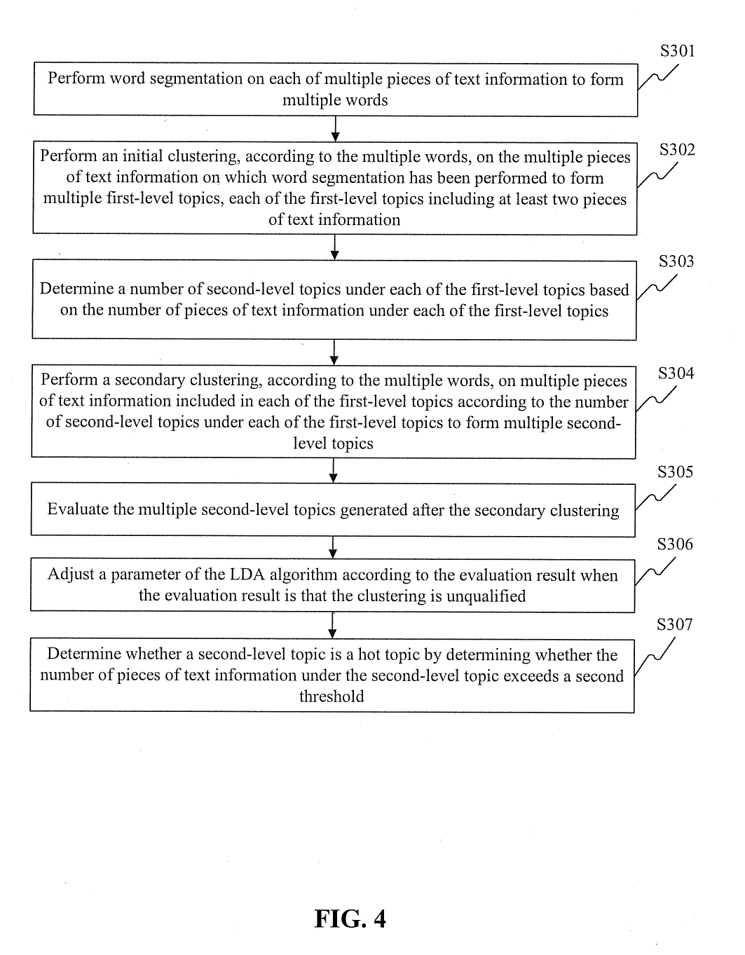

Embodiments of the disclosure further provide a text information clustering method. FIG. 4 illustrates a flowchart of a text information clustering method according to embodiments of the disclosure. The text information clustering method can include steps S301-S307.

In step S301, word segmentation can be performed on each of multiple pieces of text information to form multiple words.

In step S302, an initial clustering can be performed, by using an LDA algorithm and according to the multiple words, on the multiple pieces of text information on which word segmentation has been performed to form multiple first-level topics, each of the first-level topics including at least two pieces of text information.

In step S303, the number of second-level topics under each of the first-level topics can be determined based on the number of pieces of text information under each of the first-level topics.

In step S304, an secondary clustering can be performed (e.g., by using the LDA algorithm), according to the multiple words, on the at least two pieces of text information included in each of the first-level topics according to the number of second-level topics under each of the first-level topics to form multiple second-level topics.

The four steps S301-S304 can be same as or similar to the above steps S101-S104, and thus are not described in detail here.

After step S304, steps S305-S306 can be performed.

In step S305, matching degrees of the multiple second-level topics generated after the secondary clustering can be evaluated to determine whether the clustering is unqualified.

In step S306, a parameter of the LDA algorithm can be adjusted according to the matching degrees when the clustering is unqualified.

In some embodiments, when the clustering is unqualified, the number of topics, a frequency threshold for low-frequency words, a threshold for the number of pieces of text information included in topics to be merged, content of a stop list, and the like can be adjusted. The number of topics is, for example, the value k in FIG. 1. The frequency threshold for low-frequency words can be, for example, a threshold set manually or by a machine. After word segmentation is performed on all text information, an occurrence frequency of a word or occurrence frequencies of some words is/are less than the threshold, and such words can be considered as low-frequency words. In this step, the frequency threshold for low-frequency words can be adjusted to increase or decrease the number of the low-frequency words, thus affecting the clustering result. The threshold for the number of pieces of text information included in topics to be merged is, for example, a threshold set manually or by a machine. When the number of pieces of text information included in one or more topics is less than a specific threshold, it can be considered that the topics need to be merged. By modifying this threshold, a higher merging threshold or a lower merging threshold can be set, thus affecting the clustering result. The stop list can be, for example, a table that stores multiple stop words. The clustering result can be influenced by adjusting the content of the stop words.

In this step, second-level topics generated after clustering can be evaluated by manual evaluation or a machine algorithm. The result of secondary clustering may change a lot as text information differs. Therefore, it is necessary to evaluate the result of secondary clustering. A specific evaluation method can include checking whether text information under several second-level topics is related to same content, and determining whether the clustering is appropriate, whether an inappropriate word is selected as a keyword, whether aliasing occurs in the second-level topics, whether the number of first-level topics and the number of second-level topics are selected appropriately, and so on. If the result is not as expected, adjustment can be continued manually or based on a machine algorithm as required. For example, a parameter of the LDA algorithm can be adjusted, or the like.

In some embodiment, after step S304, the method can further include step S307.

In step S307, it can be determined whether a second-level topic is a hot topic by determining whether the number of pieces of text information under the second-level topic exceeds a second threshold.

In some embodiments, when the number of pieces of text information under a second-level topic exceeds a second threshold, the second-level topic can be determined as a hot topic. After the second-level topic is determined as a hot topic, subsequent operations can be performed. For example, the hot topic can be automatically or manually displayed on the home page of a website, the hot topic is marked conspicuously, and so on, but the present disclosure is not limited to these operations.

In the text information clustering method, a hierarchical clustering method is used in the text information clustering method. The total number of first-level topics can be decreased in the initial clustering, thus improving the computing efficiency and reducing the consumption of system resources. In the secondary clustering, the number of second-level topics can be dynamically determined according to the number of pieces of text information, thus decreasing the average number of pieces of text info nation under each second-level topic and accelerating the computing speed of the second-level topics. At the same time, an evaluation step is performed after the secondary clustering is completed, to evaluate whether the clustering of the second-level topics is appropriate. The addition of the foregoing evaluation step can further optimize the clustering method and improve the accuracy of the clustering. In addition, after the secondary clustering is completed, it can be judged which second-level topics are hot topics upon comparison with a second threshold, thus facilitating the subsequent processing.

In the above embodiments, the text information clustering method can be, for example, applied to clustering of news. That is, the text information can be, for example, news. A lot of news can be clustered by using the method. As a huge number of news will be produced in everyday life, the news can be clustered faster using the methods of the disclosure. The methods can avoid the complexity and inefficiency of manual classification, facilitate users to obtain classified news faster, and improve the user experience.

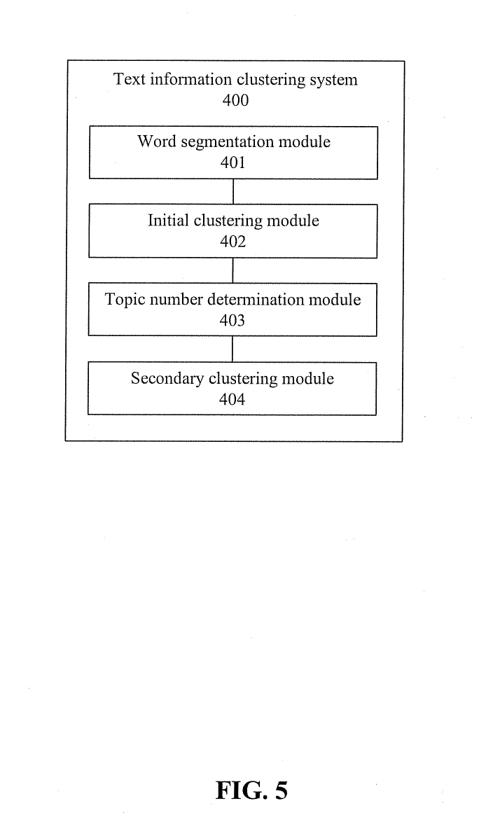

Embodiments of the disclosure also provide a text information clustering system. FIG. 5 illustrates a block diagram of a text information clustering system 400, according to embodiments of the present disclosure. System 400 can include a word segmentation module 401, an initial clustering module 402, a topic number determination module 403, and a secondary clustering module 404.

Word segmentation module 401 can be configured to perform word segmentation on each of multiple pieces of text information to form multiple words.

Initial clustering module 402 can be configured to perform, according to the multiple words, initial clustering on the multiple pieces of text information on which word segmentation has been performed to form multiple first-level topics, each of the first-level topics including at least two pieces of text information.

Topic number determination module 403 can be configured to determine the number of second-level topics under each of the first-level topics based on the number of pieces of text information under each of the first-level topics according to a preset rule.

Secondary clustering module 404 can be configured to perform, according to the multiple words, secondary clustering on multiple pieces of text information included in each of the first-level topics according to the number of second-level topics under each of the first-level topics, to form multiple second-level topics.

In the text information clustering system, a hierarchical clustering system is used for performing text information clustering described above. The total number of first-level topics is decreased in initial clustering, thus improving the computing efficiency and reducing the consumption of system resources. In secondary clustering, the number of second-level topics is dynamically determined according to the number of pieces of text information, thus decreasing the average number of pieces of text information under each second-level topic and accelerating the computing speed of the second-level topics.

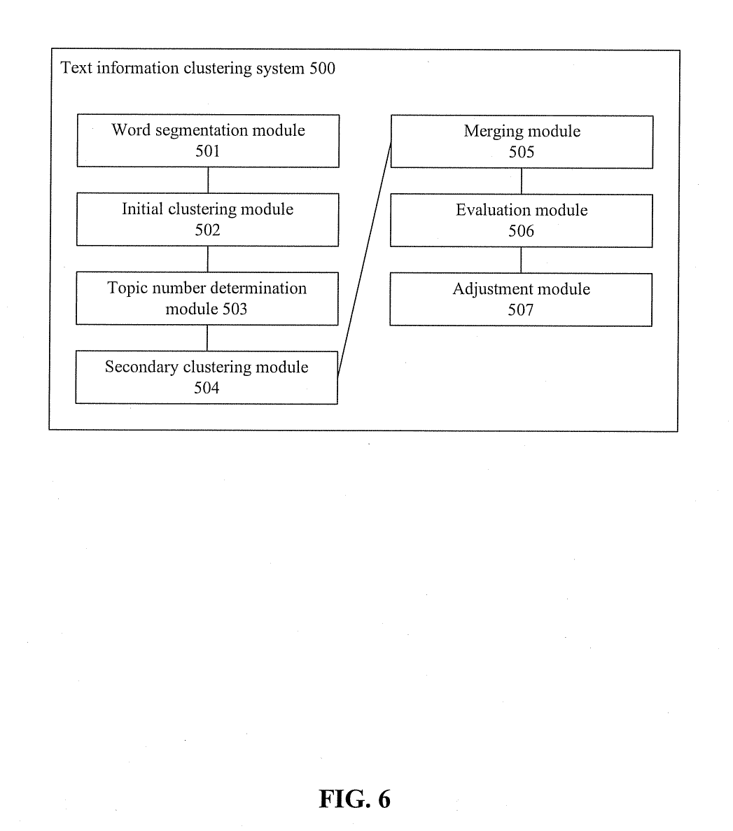

Embodiments of the disclosure further provide a text information clustering system. FIG. 6 illustrates a block diagram of a text information clustering system according to embodiments of the present disclosure. The text information clustering system can include: a word segmentation module 501, an initial clustering module 502, a topic number determination module 503, and a secondary clustering module 504. Modules 501-504 are the same as or similar to above modules 401-404, and are not described in detail here.

In some embodiments, the initial clustering and the secondary clustering both employ an LDA algorithm for clustering.

In some embodiments, the system further includes: a correlation degree determination module and a first deletion module.

The correlation degree determination module can be configured to determine a degree of correlation between a symbol, an English word and/or a number and the text information when the presence of the symbol, the English word and/or the number is detected in the text information; and

The first deletion module can be configured to delete the symbol, the English word and/or the number when it is judged that the degree of correlation between the symbol, the English word and/or the number and the text information is lower than a designated value.

In some embodiments, the system further includes: a detection module configured to detect whether each of the words after the word segmentation is the same as a word in a preset stop list; and a second deletion module configured to delete any word after the word segmentation that is detected to be the same as a word in the preset stop list.

In some embodiments, the system further includes: a merging module 505 configured to merge two or more first-level topics, in which the number of pieces of included text information is less than a first value, into a first-level topic.

In some embodiments, the secondary clustering module 504 is further configured to implement any two or more secondary clustering processes at the same time.

In some embodiments, the system further includes: an evaluation module 506 configured to evaluate matching degrees of the multiple second-level topics generated after the secondary clustering; and an adjustment module 507 configured to adjust a parameter of the LDA algorithm according to the evaluation result of the matching degrees.

In some embodiments, the system further includes: a hot topic determination module 508 configured to determine, according to the number of pieces of text information under each of the second-level topics, whether the second-level topic is a hot topic.

In the text information clustering system according to embodiments of the disclosure, a hierarchical clustering system is used in the text information clustering system. The total number of first-level topics is decreased in initial clustering, thus improving the computing efficiency and reducing the consumption of system resources. In secondary clustering, the number of second-level topics is dynamically determined according to the number of pieces of text information, thus decreasing the average number of pieces of text information under each second-level topic and accelerating the computing speed of the second-level topics.

At the same time, in the secondary clustering, the system dynamically determines the number of second-level topics according to the number of pieces of text information, thus decreasing the average number of pieces of text information under each second-level topic and accelerating the computing speed of the second-level topics. Meanwhile, meaningless words and/or symbols are deleted during clustering, and first-level topics including a small number of pieces of text information are merged, thus further optimizing the computing method, and reducing the computing load.

At the same time, the system in this embodiment may include an evaluation module configured to evaluate whether the clustering of the second-level topics is appropriate. The addition of the foregoing evaluation step can further optimize the clustering method and improve the accuracy of the clustering. In addition, the system in this embodiment can include a hot topic judgment module that can judge which second-level topics are hot topics upon comparison with a second threshold, thus facilitating the subsequent processing.

Similarly, in the above multiple embodiments, the text information clustering system can be, for example, applied to clustering of news. That is, the text information may be, for example, news. A lot of news can be clustered by using the system.

The clustering system at least can include: a word segmentation module, an initial clustering module, a topic number determination module, and a secondary clustering module.

The word segmentation module can be configured to perform word segmentation on each of multiple pieces of news to form multiple words.

The initial clustering module can be configured to perform initial clustering, according to the multiple words, on the multiple pieces of news on which word segmentation has been performed to form multiple first-level topics, each of the first-level topics including multiple pieces of news.

The topic number determination module can be configured to determine the number of second-level topics under each of the first-level topics based on the number of pieces of news under each of the first-level topics according to a preset rule.

The secondary clustering module can be configured to perform secondary clustering, according to the multiple words, on multiple pieces of news included in each of the first-level topics according to the number of second-level topics under each of the first-level topics to form multiple second-level topics.

As a lot of news can be produced in everyday life, the news can be clustered faster through the above steps, which avoids the complexity and inefficiency of manual classification, facilitates users to obtain classified news faster, and improves the user experience.

The systems can be similar to the above methods. For related parts, refer to the descriptions of the parts in the above methods.

Embodiments in this disclosure are all described in a progressive manner, each embodiment emphasizes a part different from other embodiments, and identical or similar parts in the embodiments may be obtained with reference to each other.

It is appreciated that, embodiments of the present disclosure may be provided as a method, an apparatus, or a computer program product. Therefore, embodiments of the present disclosure may be implemented in the form of a complete hardware embodiment, a complete software embodiment, or an embodiment combining software and hardware. Moreover, embodiments of the present disclosure may be in the form of a computer program product implemented on one or more computer usable storage media (including, but not limited to, a magnetic disk memory, a CD-ROM, an optical memory, and the like) including computer usable program codes.

In a typical configuration, the computer device includes one or more central processing units (CPUs), an input/output interface, a network interface, and a memory. The memory may include a volatile memory, a random access memory (RAM) and/or a non-volatile memory or the like in a computer readable medium, for example, a read-only memory (ROM) or a flash RAM. The memory is an example of the computer readable medium. The computer readable medium includes non-volatile and volatile media as well as movable and non-movable media, and can implement signal storage by means of any method or technology. A signal may include data such as a computer readable instruction, a data structure, and a module of a program or other data. A storage medium of a computer includes, but is not limited to, for example, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and can be used to store signals accessible to a computing device. According to the definition in this text, the computer readable medium does not include transitory media, such as modulated data signals and carriers.

Embodiments of the present disclosure are described with reference to flowcharts and/or block diagrams according to the method, terminal device (system) and computer program product of the embodiments of the present application. It is appreciated that a computer program instruction may be used to implement each process and/or block in the flowcharts and/or block diagrams and combinations of processes and/or blocks in the flowcharts and/or block diagrams. The computer program instructions may be provided to a universal computer, a dedicated computer, an embedded processor or a processor of another programmable data processing terminal device to generate a machine, such that the computer or the processor of another programmable data processing terminal device executes the instructions to generate an apparatus configured to implement functions designated in one or more processes in a flowchart and/or one or more blocks in a block diagram.

The computer program instructions may also be stored in a computer readable storage that can guide a computer or another programmable data processing terminal device to work in a specific manner, such that the instructions stored in the computer readable storage generate an article of manufacture including an instruction apparatus, and the instruction apparatus implements functions designated by one or more processes in a flowchart and/or one or more blocks in a block diagram.

The computer program instructions may also be loaded in a computer or another programmable data processing terminal device, such that a series of operation steps are executed on the computer or another programmable terminal device to generate computer-implemented processing. Therefore, the instructions executed in the computer or another programmable terminal device provide steps for implementing functions designated in one or more processes in a flowchart and/or one or more blocks in a block diagram.

Embodiments of the present disclosure have been described. However, once knowing the basic creative concepts, other variations and modifications can be made to the embodiments. Therefore, the appended claims are intended to be explained as including the above embodiments and all variations and modifications falling within the scope of the disclosure.

The relation terms herein such as first and second are merely used to distinguish one entity or operation from another entity or operation, and do not require or imply that the entities or operations have this actual relation or order. Moreover, the terms “include”, “comprise” or their other variations are intended to cover non-exclusive inclusion, so that a process, method, article or terminal device including a series of elements not only includes the elements, but also includes other elements not clearly listed, or further includes inherent elements of the process, method, article or terminal device. In the absence of more limitations, an element defined by “including a/an . . . ” does not exclude that the process, method, article or terminal device including the element further has other identical elements.

A text information clustering method and a text information clustering system provided in the present disclosure are described in detail above, and the principles and implementations of the present disclosure are described by applying specific examples in this text. The above descriptions about the embodiments are merely used to help understand the method of the present disclosure and its core ideas. Meanwhile, for those of ordinary skill in the art, there can be modifications to the specific implementation manners and application scopes according to the idea of the present disclosure. Therefore, the content of the specification should not be construed as limiting the present disclosure.

1. A text information clustering method, comprising:
performing word segmentation on multiple pieces of text information to generate multiple words;
performing an initial clustering on the multiple words to generate multiple first-level topics, each of the first-level topics comprising at least two pieces of text information;
determining, for each of the first-level topics; a number of second-level topics based on a number of pieces of text information under the first-level topic; and
performing, according to the number of second-level topics of each of the first-level topics, a secondary clustering on the multiple words of at least two pieces of text information comprised in the first-level topic to generate multiple second-level topics.

2. The text information clustering method according to claim 1, wherein the initial clustering and the secondary clustering employ a Latent Dirichlet Allocation (LDA) algorithm to cluster the multiple words into the multiple first-level topics and the multiple second-level topics.

3. The text information clustering method according to claim 1, wherein after performing word segmentation on each of multiple pieces of text information, the method further comprises:
detecting, in the text information, at least one of a symbol, an English word, or a number;
determining a correlation degree between the detected at least one of the symbol, the English word, or the number and the text information; and
deleting the at least one of the symbol, the English word, or the number when the correlation degree is lower than a designated value.

4. The text information clustering method according to claim 1, wherein after performing the word segmentation on each of multiple pieces of text information to generate the multiple words, the method further comprises:
detecting whether any of the multiple words is included in a stop list; and
in response to the detection of at least one word being included in the stop list, deleting the at least one word.

5. The text information clustering method according to claim 1, wherein after performing the initial clustering on the multiple words to generate the multiple first-level topics, the method further comprises:
merging at least two first-level topics as one first-level topic, wherein a number of pieces of text information included in the at least two first-level topics is less than a threshold value.

6. The text information clustering method according to claim 1, wherein two or more secondary clusterings are performed simultaneously.

7. The text information clustering method according to claim 1, wherein after performing, according to the number of second-level topics of each of the first-level topics, a secondary clustering on the multiple words of at least two pieces of text information comprised in the first-level topic to generate multiple second-level topics, the method further comprises:
determining, according to a number of pieces of text information under each second-level topic, whether the second-level topic is a hot topic.

8. The text information clustering method according to claim 2, wherein after performing, according to the number of second-level topics of each of the first-level topics, a secondary clustering on the multiple words of at least two pieces of text information comprised in the first-level topic to generate multiple second-level topics, the method further comprises:
evaluating matching degrees of the multiple second-level topics; and
adjusting one or more parameters of the LDA algorithm according to the matching degrees.

9. (canceled)

10. A text information clustering system, comprising:
a memory storing a set of instructions; and
a processor configured to execute the set of instructions to cause the system to:
perform word segmentation on multiple pieces of text information to generate multiple words;
perform an initial clustering on the multiple words to generate multiple first-level topics, each of the first-level topics comprising at least two pieces of text information;
determine, for each of the first-level topics, a number of second-level topics based on a number of pieces of text information under the first-level topic; and
perform, according to the number of second-level topics of each of the first-level topics, a secondary clustering on the multiple words of at least two pieces of text information comprised in the first-level topic to generate multiple second-level topics.

11. The text information clustering system according to claim 10, wherein the initial clustering and the secondary clustering both employ a Latent Dirichlet Allocation (LDA) algorithm to cluster the multiple words into the multiple first-level topics and the multiple second-level topics.

12. The text information clustering system according to claim 10, wherein the processor is further configured to execute the set of instructions to cause the system to:
detect, in the text information, at least one of a symbol, an English word, or a number;
and determine a correlation degree between the detected at least one of the symbol, the English word, or the number and the text information; and
delete the at least one of the symbol, the English word, or the number when the correlation degree is lower than a designated value.

13. The text information clustering system according to claim 10, wherein the processor is further configured to execute the set of instructions to cause the system to:
detect whether any of the multiple words is included in a stop list; and
in response to the detection of at least one word being included in the stop list, delete the at least one word.

14. The text information clustering system according to claim 10, wherein the processor is further configured to execute the set of instructions to cause the system to:
merge at least two first-level topics as one first-level topic, wherein a number of pieces of text information included in the at least two first-level topics is less than a threshold value.

15. The text information clustering system according to claim 10, wherein two or more secondary clusterings are performed simultaneously.

16. The text information clustering system according to claim 10, wherein the processor is further configured to execute the set of instructions to cause the system to:
determine, according to a number of pieces of text information under each second-level topic, whether the second-level topic is a hot topic.

17-18. (canceled)

19. A non-transitory computer readable medium that stores a set of instructions that is executable by at least one processor of a computer system to cause the computer system to perform a text information clustering method, the method comprising:
performing word segmentation on each of multiple pieces of text information to generate multiple words;
performing an initial clustering on the multiple words to generate multiple first-level topics, each of the first-level topics comprising at least two pieces of text information;
determining, for each of the first-level topics, a number of second-level topics based on a number of pieces of text information under the first-level topic; and
performing, according to the number of second-level topics of each of the first-level topics, a secondary clustering on the multiple words of at least two pieces of text information comprised in the first-level topic to generate multiple second-level topics.

20. The non-transitory computer readable medium according to claim 19, wherein the initial clustering and the secondary clustering employ a Latent Dirichlet Allocation (LDA) algorithm to cluster the multiple words into the multiple first-level topics and the multiple second-level topics.

21. The non-transitory computer readable medium according to claim 19, wherein after performing word segmentation on each of multiple pieces of text information and wherein the set of instructions that is executable by the computer system to cause the computer system to further perform:
detecting, in the text information, at least one of a symbol, an English word, or a number;
determining a correlation degree between the detected at least one of the symbol, the English word, or the number and the text information; and
deleting the at least one of the symbol, the English word, or the number when the correlation degree is lower than a designated value.

22. The non-transitory computer readable medium according to claim 19, wherein after performing the word segmentation on each of multiple pieces of text information to generate the multiple words and wherein the set of instructions that is executable by the computer system to cause the computer system to further perform:
detecting whether any of the multiple words is included in a stop list; and
in response to the detection of at least one word being included in the stop list, deleting the at least one word.

23. The non-transitory computer readable medium according to claim 19, wherein after performing the initial clustering on the multiple words to generate the multiple first-level topics and wherein the set of instructions that is executable by the computer system to cause the computer system to further perform:
merging at least two first-level topics as one first-level topic, wherein a number of pieces of text information included in the at least two first-level topics is less than a threshold value.

24-27. (canceled)
